(19) United States
(12) Patent Application Publication
(10) Pub. No.: US 2008/0303230 A1
(43) Pub. Date: Dec. 11, 2008

(54) Shopping cart handle protector

(76) Inventor: Louise Caroline Somberg, East Greenwich, RI (US)

Correspondence Address: SALTER & MICHAELSON;THE HERITAGE BUILDING, 321 SOUTH MAIN STREET, PROVIDENCE, RI, 029037128, US

(21) Appl. No.: 11/899,078

(22) Filed: Sep. 4, 2007

Related U.S. Application Data
(60) Provisional application No. 60/933,536, filed on Jun. 7, 2007.
(60) Provisional application No. 60/958,215, filed on Jul. 3, 2007.

(51) Int. Cl. B62B 5/00; A47B 95/02; B62B 5/06; B62B 3/02

(52) U.S. Cl. 280/33.992; 16/435

(57) ABSTRACT

A wrap or cover is shown for a handle to protect against germs or bacteria on the handle. The wrap or cover includes a pair of layers of a soft washable material having a length greater than the width and joined at their periphery by a stitching of the respective materials that comprise the layers so as to form a unitary wrap layer. A set of fasteners is attached respectively to opposite sides of the wrap layer. Each fastener includes a strip of fastener material having a length greater than its width. Each fastener comprises a Velcro material that includes a Velcro loop and a Velcro hook material.

### RELATED APPLICATION

Priority for this application is hereby claimed under 35 U.S.C. § 119(e) to commonly owned and co-pending U.S. Provisional Patent Application Nos. 60/933,536 which was filed on Jun. 7, 2007 and 60/958,215 filed on Jul. 3, 2007; each of which were filed in the name of Louise Caroline Somberg, and each of which is incorporated by reference herein in its entirety.

### TECHNICAL FIELD

The present invention relates in general to a protector for a shopping cart handle. More particularly, the present invention relates to a protective wrap for use about a shopping cart handle. The present invention also describes a protective wrap that can be used for a variety of other uses including, but not limited to, a wrap for exercise equipment handles or stroller handles.

### BACKGROUND OF THE INVENTION

A shopping cart handle is typically contacted by a number of different users during the course of use. Thus, the shopping cart handle is subject to retaining undesirable germs and bacteria. Sanitary wipes may be used to wipe the handle. However, these are not readily available and are not usually carried by the user. Also, in addition to the sanitary wipe one would also have to carry a towel or the like to dry the handle, which is inconvenient.

Related prior art patents are U.S. Pat. Nos. 5,215,319 to Farris; 5,427,392 and 5,429,377 to Duer and 6,543,794 to Tyree. These patents show handle covers, but generally they are rather complex in construction and are not effective in providing a simple wrap that can be manufactured easily and that in particular can be readily attached and detached from the shopping cart handle. For example, the above '319 and '794 patents rely on rather ineffective fasteners, using only separate spaced fasteners which do not provide a secure attachment for the cover. The '377 and '392 patents also show fasteners but they are generally too narrow in construction and thus do not provide a secure fit for the cover.

Accordingly, it is an object of the present invention to provide an improved means for protecting the user from germs and bacteria that are manifested at the handle of a shopping cart or other handle structure.

Another object of the present invention is to provide an improved handle cover that is simple in manufacture, can be constructed relatively inexpensively and provides a secure fit to the handle with which it is being used.

### SUMMARY OF THE INVENTION

In accordance with the present invention there is provided a handle protector that may be used with shopping carts, strollers or exercise equipment and preferably in the form of a wrap that has associated therewith some type of a fastening means such as the preferred elongated Velcro strips. This enables the user to wrap the protector about the handle so as to protect the user from germs and the like that reside on the handle. In accordance with the present invention the wrap may also be provided with advertising thereon. The wrap or cover is also readily rolled up for storage in a bag.

In accordance with the invention there is provided a cover for a handle of a shopping cart comprising, at least one layer of a soft washable material having a length of at least 12 inches and a width of at least 4 inches; a set of fasteners attached respectively to opposite sides of the layer; each fastener including a strip of fastener material having a length greater than its width; and each fastener comprising a Velcro material that includes a Velcro loop and a Velcro hook material.

In accordance with other aspects of the present invention the cover may include a pair of layers of soft washable material; may include a foam material between the respective layers of soft washable material; may include a stitch at the periphery of the layers for attaching the layers together; wherein the stitch may be a button-hole stitch; may include at least one stitch for holding each fastener strip to the layers; wherein each stitch for holding each fastener strip to the layers may comprise a double stitch; wherein each of the strips may have a width on the order of ¾-1 inch; wherein the length of the cover is preferably in the range of 16-22 inches; wherein the width of the cover is preferably between 4 and 5 inches; wherein the width of each strip may be on the order of one-sixth the overall width of the strip.

In accordance with other embodiments of the invention there is provided a wrap for a handle to protect against germs or bacteria on the handle. The wrap comprises a pair of layers of a soft washable material having a length greater than the width and joined at their periphery by a stitching of the respective materials that comprise the layers so as to form a unitary wrap layer; a set of fasteners attached respectively to opposite sides of the wrap layer; each fastener including a strip of fastener material having a length greater than its width; and each fastener comprising a Velcro material that includes a Velcro loop and a Velcro hook material.

In accordance with other aspects of the invention the cover may include a foam material between the respective layers of soft washable material; wherein the peripheral stitch may be a button-hole stitch; may include a double stitch for holding each fastener strip to the layers; wherein each of the strips may have a width on the order of ¾-1 inch; wherein the length of the wrap is preferably in the range of 16-22 inches; wherein the width of the cover may be between 4 and 5 inches and wherein the width of each strip is preferably on the order of one-sixth the overall width of the strip.

### DESCRIPTION OF THE DRAWINGS

It should be understood that the drawings are provided for the purpose of illustration only and are not intended to define the limits of the disclosure. The foregoing and other objects and advantages of the embodiments described herein will become apparent with reference to the following detailed description when taken in conjunction with the accompanying drawings in which:

FIG. 1 is a perspective view of a shopping cart showing the shopping cart handle and the protector wrap or cover of the present invention as fitted to the handle;

FIG. 2 is a plan view showing the front side of the protector wrap;

FIG. 3 is a view of the opposite back side of the protector wrap;

FIG. 4 is a cross-sectional view through the wrap;

FIG. 5 is a perspective view illustrating the protector wrap of the present invention in its wrapped position; and

FIG. 6 is a perspective view of a bag used for holding the wrap.

### DETAILED DESCRIPTION

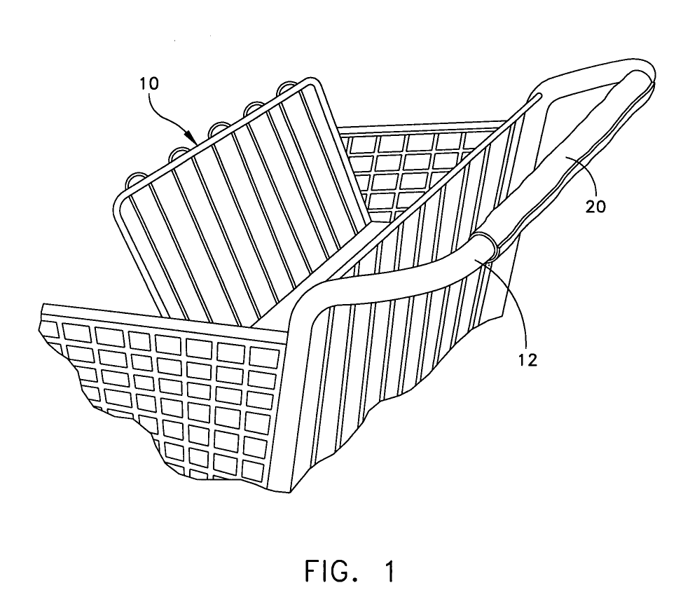

FIG. 1 shows a typical shopping cart at 10. The shopping cart 10 typically has a handle 12 that is used to push the shopping cart. Such shopping carts are widely used in supermarkets and other public venues. FIG. 1 also shows the protector wrap or cover 20 of the present invention as exploded away from the handle 12. The cover 20 can also be used wrapped about other types of handle such used with strollers, carriages or exercise equipment. The cover is preferably made of a soft material such as neoprene and thus has some stretch qualities. It is also readily washable to remove any germs or bacteria. It can then be stored in a bag as shown in FIG. 6 and inserted into a pocket book or other carrying case for convenience.

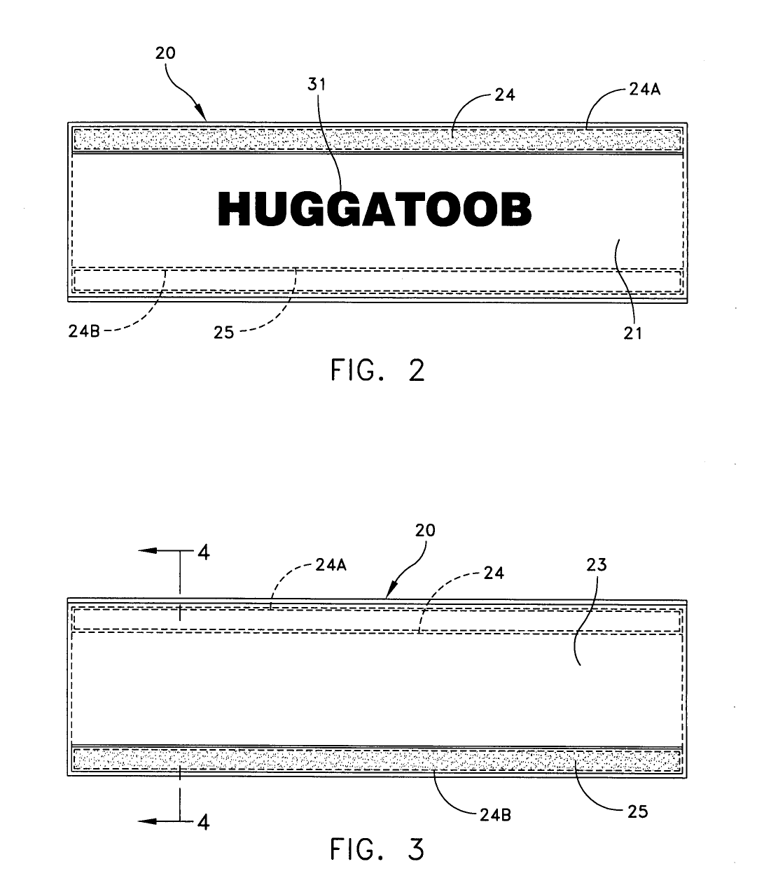

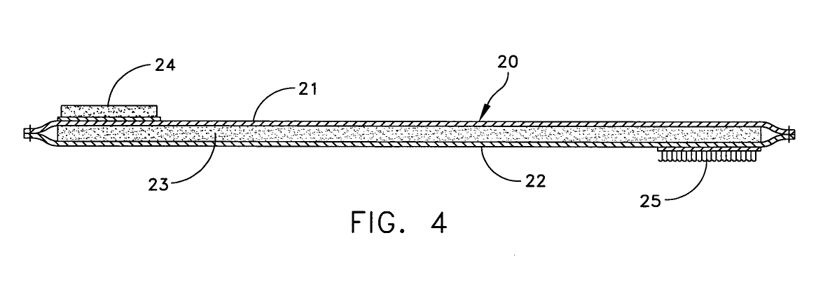

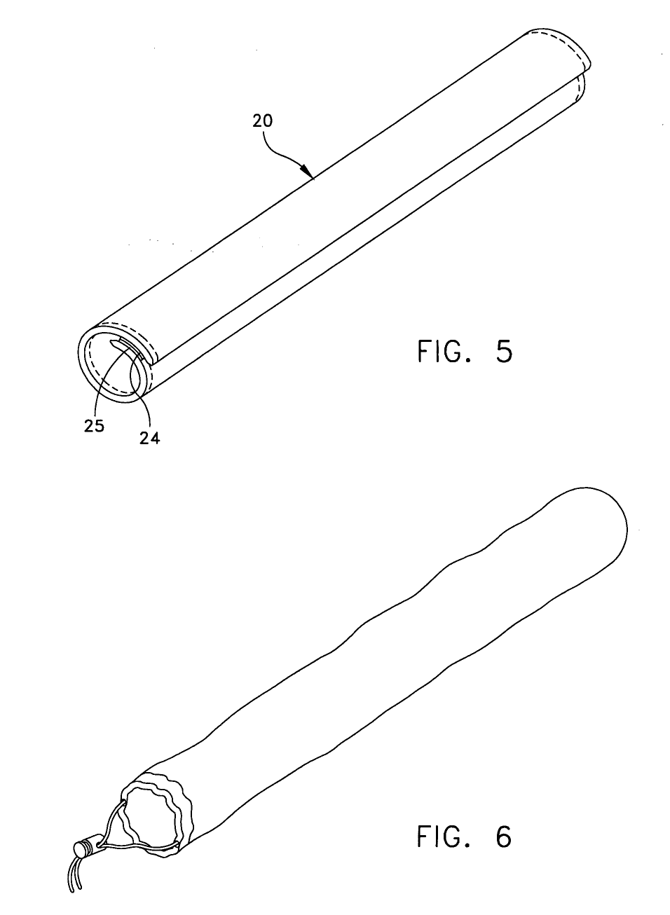

Reference is now made to FIGS. 2 and 3. FIG. 2 shows a plan view of the front side of the protector wrap 20 while FIG. 3 shows the opposite back side of the protector wrap, both in their unwrapped state. The length of the wrap 20 is preferably somewhere in the range of 16-22 inches and the width, as illustrated in FIG. 2 is preferably between 4 and 5 inches. As illustrated in FIGS. 2 and 3 on either opposed side of the wrap are provided securing strips 24 and 25 that may each comprise a Velcro strip. One of the strips 25 is on the reverse side so that the strips can contact each other in securing the wrap about the handle 12. Each of the Velcro strips 24, 25 may have a width on the order of ¾-1 inch. The strip 24 may be the loop type fastener while the strip 25 may be the corresponding hook type fastener. The width of each strip is on the order of one-sixth the overall width of the strip.

The wrap 20 of the present invention is preferably constructed of a lightweight, non-porous material. A form of neoprene may be used and the material may be provided in two separate but attached layers 21 and 22. The separate layers may be attached together and be provided with a rubber or foam type filling 23 therebetween. Each layer may be 3 mil thick and the foam material may be 3-6 mil thick. The layers 21 and 22 are attached together by a peripheral stitching indicated at 20A that extends about the entire periphery of the layers 21, 22. The stitching is preferably a button-hole stitch. In addition, the Velcro strips 24 and 25 are both preferably attached to the layers by a double stitch which is respectively double stitches 24A and 24B shown in the drawings.

It is intended that the wrap be carried by the user and wrapped about the shopping cart handle so that the user no longer makes any direct contact with the handle but instead contacts the wrap material. When the user is through with the use of the shopping cart then the wrap is simply removed and can then be put into the user's pocket or handbag. The wrap of the present invention is intended to be sanitized at a later time such as by being wiped with a sanitary cloth, washed or otherwise sterilized in an appropriate manner.

The wrap material is intended to be carried by the user and once entering a supermarket or other establishment, the wrap is wrapped about the handle in a position where the user no longer has to directly contact the handle of the shopping cart.

In accordance with the present invention the wrap may also be provided with advertising thereon. This may be printed on the material or applied in any other way. The advertising or indicia at 31 is viewable once the wrap is placed. FIG. 2 shows the indicia 31 on the front side of the wrap. The wrap is also reversible and thus one can provide advertising or other indicia on both sides of the wrap.

The described embodiment shows the protective wrap for use with a shopping cart handle. However, it is understood that, in accordance with the principles of the present invention, the same or a similar wrap may also be used about other types of handles including, but not limited to, stroller handles, carriage handles and handles used in a variety of different types of exercise equipment. Moreover the protector wrap of the present invention can be used about virtually any other handle apparatus where the user comes into contact with the handle apparatus.

Having now described a limited number of embodiments of the present invention, it should be apparent to those skilled in the art that numerous other embodiments and modifications thereof are contemplated as falling within the scope of the present invention as defined by the appended claims.

What is claimed is:

1. A cover for a handle of a shopping cart comprising:
at least one layer of a soft washable material having a length of at least 12 inches and a width of at least 4 inches;
a set of fasteners attached respectively to opposite sides of the layer;
each fastener including a strip of fastener material having a length greater than its width; and
each fastener comprising a Velcro material that includes a Velcro loop and a Velcro hook material.

2. The cover of claim 1 including a pair of layers of soft washable material.

3. The cover of claim 2 including a foam material between the respective layers of soft washable material.

4. The cover of claim 2 including a stitch at the periphery of the layers for attaching the layers together.

5. The cover of claim 4 wherein the stitch is a button-hole stitch.

6. The cover of claim 4 including at least one stitch for holding each fastener strip to the layers.

7. The cover of claim 6 wherein each stitch for holding each fastener strip to the layers comprises a double stitch.

8. The cover of claim 4 wherein each of the strips has a width on the order of ¾-1 inch.

9. The cover of claim 4 wherein the length of the cover is preferably in the range of 16-22 inches

10. The cover of claim 9 wherein the width of the cover is between 4 and 5 inches.

11. The cover of claim 4 wherein the width of each strip is on the order of one-sixth the overall width of the strip.

12. A wrap for a handle to protect against germs or bacteria on the handle, said wrap comprising:
a pair of layers of a soft washable material having a length greater than the width and joined at their periphery by a stitching of the respective materials that comprise the layers so as to form a unitary wrap layer;
a set of fasteners attached respectively to opposite sides of the wrap layer;
each fastener including a strip of fastener material having a length greater than its width; and
each fastener comprising a Velcro material that includes a Velcro loop and a Velcro hook material.

13. The cover of claim 12 including a foam material between the respective layers of soft washable material.

14. The cover of claim 12 wherein the peripheral stitch is a button-hole stitch.

15. The cover of claim 12 including a double stitch for holding each fastener strip to the layers.

16. The cover of claim 12 wherein each of the strips has a width on the order of ¾-1 inch.

17. The cover of claim 12 wherein the length of the wrap is preferably in the range of 16-22 inches.

18. The cover of claim 17 wherein the width of the cover is between 4 and 5 inches and wherein the width of each strip is on the order of one-sixth the overall width of the strip.

19. A cover for a handle of a shopping cart comprising:
at least one layer of a soft washable material having a length of at least 12 inches and a width of at least 4 inches;
a set of fasteners attached respectively to opposite sides of the layer;
each fastener including a strip of fastener material having a length greater than its width; and
each fastener comprising a Velcro material that includes a Velcro loop and a Velcro hook material.
including a pair of layers of soft washable material;
including a foam material between the respective layers of soft washable material;
including a stitch at the periphery of the layers for attaching the layers together;
wherein the stitch is a button-hole stitch;
including at least one stitch for holding each fastener strip to the layers;
wherein each stitch for holding each fastener strip to the layers comprises a double stitch;
wherein each of the strips has a width on the order of ¾-1 inch;
wherein the length of the cover is preferably in the range of 16-22 inches;
wherein the width of the cover is between 4 and 5 inches; and
wherein the width of each strip is on the order of one-sixth the overall width of the strip.

20. The cover of claim 19 wherein the cover is for use about one or more of a shopping cart, stroller, carriage and exercise equipment.
